(19) United States
(12) Patent Application Publication
(10) Pub. No.: US 2019/0008727 A1
(43) Pub. Date: Jan. 10, 2019

(54) DEVICE TO ENABLE INFANTS WITH CLEFT PALATE TO BREAST FEED

(71) Applicant: The Board of Regents of the University of Texas System, Austin, TX (US)

(72) Inventors: James SEAWARD, Dallas, TX (US); Alex KANE, Dallas, TX (US); Rami HALLAC, Dallas, TX (US)

(21) Appl. No.: 16/067,796

(22) PCT Filed: Dec. 16, 2016
(86) PCT No.: PCT/US16/67086

§ 371 Date: Jul. 2, 2018

Related U.S. Application Data
(60) Provisional application No. 62/275,478, filed on Jan. 6, 2016.

(51) Int. Cl. A61J 11/00; A61J 13/00

(52) U.S. Cl. CPC A61J 11/006; A61J 11/0065; A61J 13/00

(57) ABSTRACT

A feeding apparatus includes a nipple shield, a deformable nipple defining a chamber, an inlet through which fluid can flow into the chamber, and an outlet through which fluid can exit the nipple, a first portion of the nipple having a first stiffness and a second portion of the nipple having a second stiffness that is lower than the first stiffness, the first portion disposed on a first side of a longitudinal plane bisecting the nipple and the second portion disposed on a second side of the plane, and a check valve disposed in the nipple to divide the chamber into a first portion between the check valve and the outlet, and a second portion between the check valve and the inlet, wherein the check valve is configured to admit fluid into the first portion but prevent fluid from leaving the first portion through the check valve.

### CROSS-REFERENCE TO RELATED APPLICATIONS

This application claim the benefit of priority of U.S. provisional patent application No. 62/275,478, filed Jan. 6, 2016, which is hereby incorporated by reference in its entirety.

### FIELD OF INVENTION

The disclosed invention relates generally to feeding apparatuses, such as feeding apparatuses for use with cleft lips and cleft palates.

### BACKGROUND

Babies with cleft palates and/or cleft lips have difficulties eating via breastfeeding or bottles. Examples of devices to facilitate breastfeeding are disclosed in U.S. Pat. No. 7,335,183, U.S. Pat. No. 8,770,202, and U.S. Pat. No. 4,856,663. Examples of devices to facilitate bottle feeding are disclosed in U.S. Pat. No. 6,968,964, U.S. Pat. No. 3,924,620, and U.S. Pat. No. 3,134,494.

### SUMMARY

The present disclosure includes embodiments of apparatus and methods to facilitate breastfeeding of infants with cleft palates.

Some embodiments of the present apparatuses comprise: a nipple shield; a deformable nipple defining a chamber, an inlet through which fluid can flow into the chamber, and an outlet through which fluid can exit the nipple, a first portion of the nipple having a first stiffness and a second portion of the nipple having a second stiffness that is lower than the first stiffness, the first portion disposed on a first side of a longitudinal plane bisecting the nipple and the second portion disposed on a second side of the plane; and a check valve disposed in the nipple to divide the chamber into a first portion between the check valve and the outlet, and a second portion between the check valve and the inlet, wherein the check valve is configured to admit fluid into the first portion but prevent fluid from leaving the first portion through the check valve. In some embodiments, the nipple includes a reinforcement member disposed on the first side of the longitudinal bisecting plane. In some embodiments, the reinforcement member is disposed in the chamber. In some embodiments, the first portion of the nipple is configured to obstruct a cleft in a human mouth. In some embodiments, the shield is configured to seal against a human breast. In some embodiments, the nipple is configured such that compression of the first portion of the chamber expels fluid through the outlet from the first portion of the chamber, and expansion of the first portion of the chamber draws fluid into the first portion of the chamber through the check valve. Some embodiments further comprise a biasing member disposed in the nipple. Some embodiments further comprise a second check valve disposed in the chamber.

Some embodiments of the present cleft feeding devices (for breastfeeding) comprise: a nipple shield configured to seal against a human breast; a nipple extending from the nipple shield; and a check valve; where the check valve and nipple cooperate to form a chamber and wherein the check valve is configured to permit fluid into the chamber. In some embodiments, the nipple and the shield are integrally formed. Some embodiments further comprise a reinforcement member extending along a longitudinal axis of the nipple. Some embodiments further comprise a biasing member disposed in the nipple. Some embodiments further comprise a second check valve, where the second check valve and the nipple form a second chamber and the biasing member is configured to bias the check valve and the second check valve away from each other.

Some embodiments of the present methods (e.g., of using a breastfeeding device) comprise: sealing the breastfeeding device against a human breast, the breastfeeding device including a nipple and a check valve that cooperates with the nipple to form a chamber; deforming the nipple from a first state to a second state to cause fluid to flow into the chamber through the check valve; and deforming the nipple from the second state to the first state to cause fluid to flow out of the chamber through an aperture in the nipple. In some embodiments, deforming the nipple from the second state to the first state includes compressing the nipple. In some embodiments, deforming the nipple from the first state to the second state includes releasing the nipple to permit the nipple to expand. In some embodiments, the nipple includes a reinforcement member and compressing the nipple includes laterally moving a lower side of the nipple towards the reinforcement member. In some embodiments, the nipple includes a biasing member disposed between the check valve and a second check valve and compressing the nipple includes longitudinally moving the second check valve towards the check valve.

The term “coupled” is defined as connected, although not necessarily directly, and not necessarily mechanically. Two items are “couplable” if they can be coupled to each other. Unless the context explicitly requires otherwise, items that are couplable are also decouplable, and vice-versa. One non-limiting way in which a first structure is couplable to a second structure is for the first structure to be configured to be coupled (or configured to be couplable) to the second structure. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a systems, or a component of a systems, that “comprises,” “has,” “includes” or “contains” one or more elements or features possesses those one or more elements or features, but is not limited to possessing only those elements or features. Likewise, a method that “comprises,” “has,” “includes” or “contains” one or more steps possesses those one or more steps, but is not limited to possessing only those one or more steps. Additionally, terms such as “first” and “second” are used only to differentiate structures or features, and not to limit the different structures or features to a particular order.

Any embodiment of any of the disclosed systems or system components (such as shields) can consist of or consist essentially of—rather than comprise/include/contain/have—any of the described elements and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures illustrate at least one of the described elements using a graphical symbol that will be understood by those of ordinary skill in the art.

FIG. 1 depicts a first side view of a first embodiment of the present feeding apparatuses.

FIG. 2 depicts a perspective view of the first embodiment.

FIG. 3 depicts a second side view of the first embodiment.

FIG. 4 depicts a front view of the first embodiment.

FIG. 5 depicts a first side view of a second embodiment of the present feeding apparatuses.

FIG. 6 depicts a second side view of the second embodiment.

FIG. 7 depicts a first side view of a third embodiment of the present feeding apparatuses.

FIG. 8 depicts a second side view of the third embodiment.

### DESCRIPTION OF ILLUSTRATIVE EMBODIMENTS

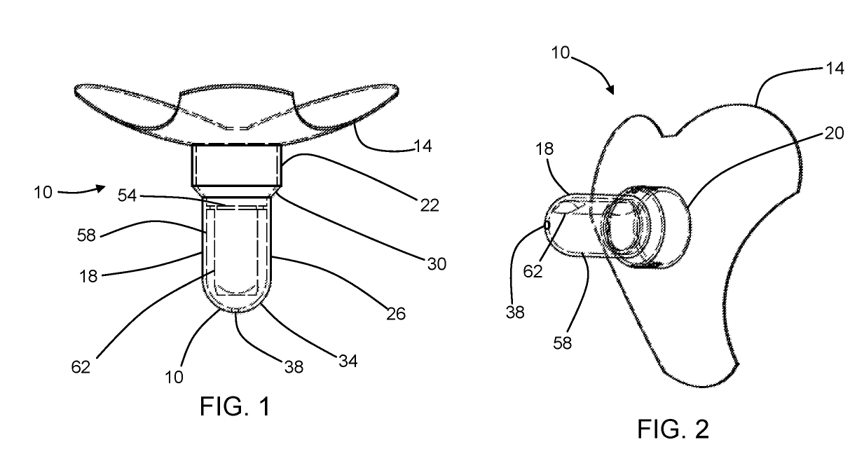

Referring now to the drawings, and more particularly to FIGS. 1-4, shown therein and designated by the reference numeral 10 is a first embodiment of the present feeding apparatuses. In the embodiment shown, apparatus 10 includes a nipple shield 14 coupled to a deformable and resilient nipple 18. In some embodiments, nipple shield 14 and nipple 18 are integrally formed. Nipple 18 extends from an aperture 20 formed in nipple shield 14. Nipple shield 14 and nipple 18 may be made of any appropriate material, such as a silicone rubber. In some embodiments, the silicone rubber of nipple shield 14 has a higher softness (e.g., is more pliable or less stiff) than the silicone rubber of nipple 18. In some embodiments, and as described below for apparatus 10, differences in stiffness between nipple 18 and shield 14 may also be provided by differences in structure (e.g., in addition to or instead of differences in material).

Nipple shield 14 is configured to fit onto a nipple of a human breast. For example, aperture 20 is configured to receive the human nipple when apparatus 10 is in use. Nipple shield 14 is configured to be conformable to contours of the human breast such that nipple shield 14 forms a seal around a nipple-areola complex of the human nipple to prevent or reduce fluid leakage at the boundary of nipple shield 14 that interfaces with the breast.

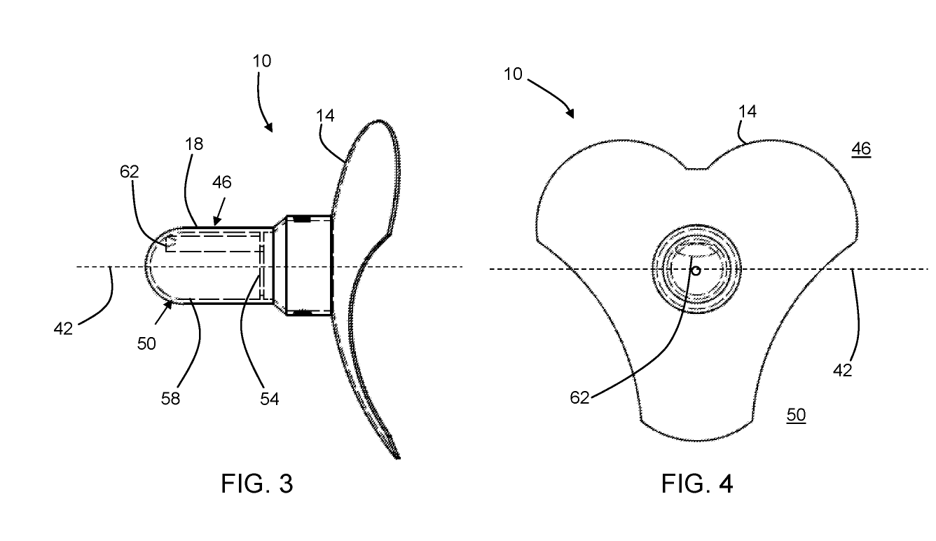

As shown, nipple 18 includes a first hollow cylindrical portion 22, a second hollow cylindrical portion 26, and a tapered portion 30 therebetween. In this embodiment, the diameter of first cylindrical portion 22 is greater than the diameter of second cylindrical portion 26 and tapered portion 30 couples first and second cylindrical portions 22, 26. First cylindrical portion 22 extends from aperture 20 of nipple shield 14. In some embodiments, nipple 18 is removable from nipple shield 14. For example, nipple shield 14 includes a protrusion extending from aperture 20 and first cylindrical portion 22 of nipple 18 is disposed around the protrusion. In some embodiments, the protrusion of the nipple shield 14 partially extends into first cylindrical portion of nipple 18. First cylindrical portion 22 may include any appropriate length for receiving the human nipple. In some embodiments, second cylindrical portion 26 is coupled to a hollow hemispheric portion 34 at an end of second cylindrical portion 26 opposite tapered portion 30. Hemispheric portion 34 includes one or more apertures 38 (one shown) toward an apex thereof. Alternatively, aperture 38 may be disposed at any appropriate position on nipple 18. A longitudinal plane 42 bisects nipple 18 between an upper side 46 and a lower side 50, as shown in FIGS. 3 and 4. Upper side 46 of nipple 18 is configured to face a roof of a mouth when apparatus 10 is in use. For example, upper side 46 of nipple 18 is configured to obstruct a cleft in the mouth. Lower side 50 of nipple 18 is configured to face a tongue of the mouth when apparatus 10 is in use.

In the embodiment shown, nipple 18 includes a check valve 54. For example, check valve 54 may be disposed in second cylindrical portion 26 of nipple 18. Alternatively, check valve 54 may be disposed in first cylindrical portion 22. Check valve 54 and an inner wall of nipple 18 form a chamber 58. Check valve 54 is configured to allow fluid flow into chamber 58 and prevent fluid flow out of chamber 58 via check valve 54. Check valve 54 may be any appropriate one-way valve as is known in the art.

In the embodiment shown, nipple 18 includes a first stiffness on upper side 46 and a second stiffness, lower than the first stiffness, on lower side 50. For example, in this embodiment, nipple 18 includes a reinforcement member 62 in chamber 58 on upper side 46. Reinforcement member 62 may be coupled to nipple 18, such as by adhesion. Alternatively, reinforcement member 62 and nipple 18 are unitary (defined by a single piece of material). In some embodiments, reinforcement member 62 is made of a relatively harder material than nipple 18. For example, reinforcement member 62 may be made of a plastic or a silicone rubber having lower elasticity than the silicone rubber of nipple 18. In some embodiments, reinforcement member 62 includes a curved upper portion corresponding to the inner wall of second cylindrical portion 26 and a flat lower portion. Alternatively, the upper portion of reinforcement member 62 may be flat and the lower portion curved.

In operation, apparatus 10 is disposed onto the human breast such that nipple shield 14 sealingly engages the human breast and the human nipple extends into first cylindrical portion 22 of nipple 18. Fluid, such as breast milk from the human breast, may fill a volume between the human breast and check valve 54. The fluid may also enter chamber 58 via check valve 54. Nipple 18 is disposed into the mouth having a cleft palate and/or cleft lip. For example, nipple 18 is positioned such that upper side 46 of nipple 18 faces (e.g., and partially or entirely obstructs) the cleft in the mouth. Thereafter, nipple 18 is deformed such that fluid exits nipple 18 via aperture 38. In one example, suction in the mouth causes nipple 18 to laterally compress. In another example, a tongue in the mouth causes nipple 18 to laterally compress. The tongue may push lower side 50 of nipple 18 toward reinforcement member 62. In turn, fluid in chamber 58 exits nipple 18 via aperture 38 and enters the mouth. Release of suction, or release of the tongue, on nipple 18 causes chamber 58 to expand. Expansion of chamber 58 generates suction on the human nipple, thereby causing fluid flow into chamber 58 via check valve 54. Nipple 18 may be repeatedly compressed and released, thereby providing additional fluid into the mouth with successive lateral compression of nipple 18.

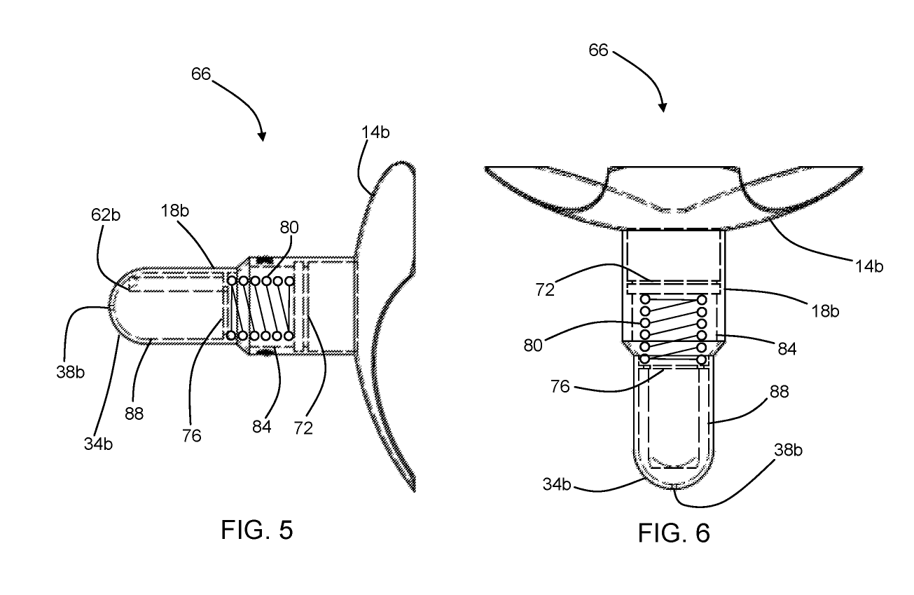

FIGS. 5 and 6 show a second embodiment 66 of the present feeding apparatuses. Features in apparatus 66 similar to features in apparatus 10 are identified with the same reference numeral and a letter “b.” Features from any embodiments disclosed herein may be combined in any arrangement unless explicitly excluded by this disclosure. In this embodiment, feeding apparatus 66 includes a nipple shield 14b coupled to a deformable nipple 18b. Alternatively nipple shield 14b and nipple 18b may be unitary (i.e., defined by a single piece of material).

In some embodiments, nipple 18b includes an aperture 38b, a first check valve 72, a second check valve 76, and a biasing member 80. In the embodiment shown, biasing member 80 is disposed between first check valve 72 and second check valve 76. Biasing member 80 is configured to bias first check valve 72 and second check valve 76 away from each other. As shown, biasing member 80 includes a helical spring, although any appropriate biasing member may be used. First and second check valves 72, 76 may be any appropriate one-way valve as is known in the art. First check valve 72, second check valve 76 and inner walls of nipple 18b form a first chamber 84. Second check valve 76 and inner walls of nipple 18b form a second chamber 88. First check valve 72 is configured to allow fluid flow into first chamber 84 and prevent fluid flow out of first chamber 84 via first check valve 72. Second check valve 76 is configured to allow fluid flow from first chamber 84 into second chamber 88 and prevent fluid flow out of second chamber 88 via second check valve 76. In some embodiments, apparatus 66 also includes a reinforcement member 62b.

In operation, apparatus 66 is disposed onto the human breast such the human nipple extends into nipple 18b as described above. Fluid, such as breast milk from the human breast, may fill a volume between the human breast and first check valve 72. The fluid may also enter first chamber 84 via first check valve 72. Nipple 18b is disposed into the mouth having the cleft palate and/or cleft lip as described above. Thereafter, nipple 18b is deformed such that fluid exits nipple 18b via aperture 38b. For example, the tongue in the mouth causes nipple 18b to compress. For example, the tongue pushes a hemispherical portion 34b of nipple 18b towards nipple shield 14b. In turn, first chamber 84 is longitudinally compressed, thereby causing fluid in first chamber 84 to flow into second chamber 88 via second check valve 76. Fluid in second chamber 88 exits nipple 18b via aperture 38b and enters the mouth. Release of nipple 18b by the tongue causes first chamber 84 to expand. Expansion of first chamber 84 generates suction on the human nipple, thereby causing fluid flow into first chamber 84 via first check valve 72. In some embodiments, compression of nipple 18b also causes second chamber 88 to compress, thereby urging fluid out of second chamber 88 via aperture 38b. In these embodiments, release of nipple 18b causes second chamber 88 to expand and generate suction, thereby causing fluid flow from first chamber 84 to second chamber 88 via second check valve 76. Nipple 18b may be repeatedly compressed and released, thereby providing additional fluid into the mouth with successive longitudinal compression of nipple 18b.

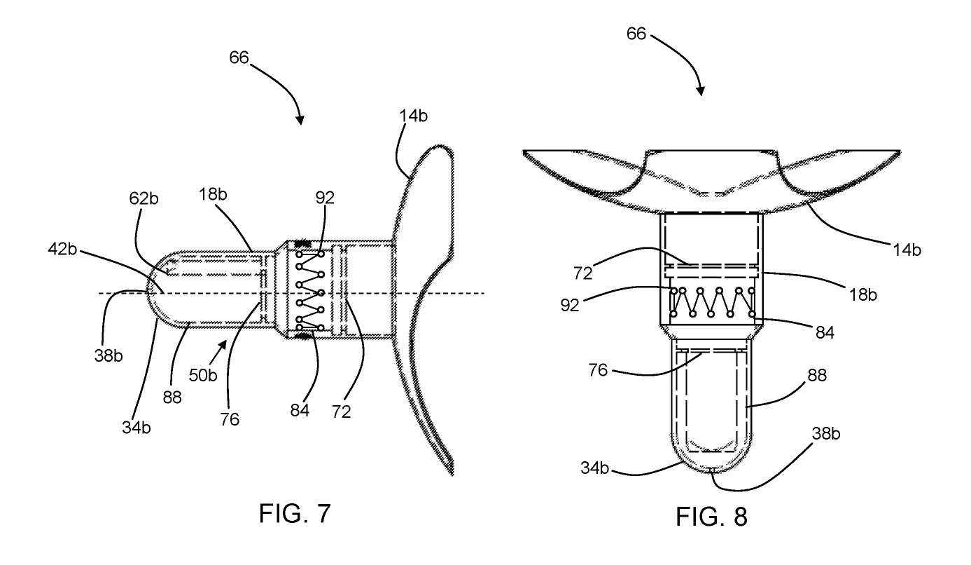

FIGS. 7 and 8 show apparatus 66 having a biasing member 92, such as a circular helical spring. Biasing member 92 is configured to bias the internal walls of nipple 18b away from each other. In this embodiment, the nipple 18b is configured to be laterally compressed. For example, in operation, the tongue in the mouth may push a lower side 50b of nipple 18b toward reinforcement member 62b. In turn, both first chamber 84 and second chamber 88 are laterally compressed, thereby causing fluid in first chamber 84 to flow into second chamber 88 via second check valve 76. Thereafter, fluid in second chamber 88 exits nipple 18b via aperture 38b and enters the mouth. Release of nipple 18b by the tongue causes both first chamber 84 and second chamber 88 to laterally expand. Expansion of first chamber 84 and/or second chamber 88 generates suction on the human nipple, thereby causing fluid flow into first chamber 84 and/or second chamber 88 via first check valve 72 and second check valve 76, respectively. Nipple 18b may be repeatedly compressed and released, thereby providing additional fluid into the mouth with successive lateral compression of nipple 18b.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the disclosed devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. An apparatus, comprising:
a nipple shield;
a deformable nipple defining a chamber, an inlet through which fluid can flow into the chamber, and an outlet through which fluid can exit the nipple, a first portion of the nipple having a first stiffness and a second portion of the nipple having a second stiffness that is lower than the first stiffness, the first portion disposed on a first side of a longitudinal plane bisecting the nipple and the second portion disposed on a second side of the plane; and
a check valve disposed in the nipple to divide the chamber into a first portion between the check valve and the outlet, and a second portion between the check valve and the inlet, wherein the check valve is configured to admit fluid into the first portion but prevent fluid from leaving the first portion through the check valve.

2. The device of claim 1, wherein the nipple includes a reinforcement member disposed on the first side of the longitudinal bisecting plane.

3. The device of claim 2, wherein the reinforcement member is disposed in the chamber.

4. The device of claim 1, wherein the first portion of the nipple is configured to obstruct a cleft in a human mouth.

5. The device of claim 1, wherein the shield is configured to seal against a human breast.

6. The device of claim 1, wherein the nipple is configured such that compression of the first portion of the chamber expels fluid through the outlet from the first portion of the chamber, and expansion of the first portion of the chamber draws fluid into the first portion of the chamber through the check valve.

7. The device of claim 1, further comprising a biasing member disposed in the nipple.

8. The device of claim 7, further comprising a second check valve disposed in the chamber.

9. A cleft feeding device for breastfeeding, comprising:
a nipple shield configured to seal against a human breast;
a nipple extending from the nipple shield; and
a check valve;
where the check valve and nipple cooperate to form a chamber and wherein the check valve is configured to permit fluid into the chamber.

10. The device of claim 9, wherein the nipple and the shield are integrally formed.

11. The device of claim 9, further comprising a reinforcement member extending along a longitudinal axis of the nipple.

12. The device of claim 9, further comprising a biasing member disposed in the nipple.

13. The device of claim 12, further comprising a second check valve, where the second check valve and the nipple form a second chamber and the biasing member is configured to bias the check valve and the second check valve away from each other.

14. A method of using a breastfeeding device, comprising:
sealing the breastfeeding device against a human breast, the breastfeeding device including a nipple and a check valve that cooperates with the nipple to form a chamber;
deforming the nipple from a first state to a second state to cause fluid to flow into the chamber through the check valve; and
deforming the nipple from the second state to the first state to cause fluid to flow out of the chamber through an aperture in the nipple.

15. The method of claim 14, where deforming the nipple from the second state to the first state includes compressing the nipple.

16. The method of claim 15, where deforming the nipple from the first state to the second state includes releasing the nipple to permit the nipple to expand.

17. The method of claim 15, where the nipple includes a reinforcement member and compressing the nipple includes laterally moving a lower side of the nipple towards the reinforcement member.

18. The method of claim 15, where the nipple includes a biasing member disposed between the check valve and a second check valve and compressing the nipple includes longitudinally moving the second check valve towards the check valve.

19. The method of claim 15, where the nipple includes a biasing member disposed between the check valve and a second check valve and the nipple is laterally compressed.
